(19) United States
(12) Patent Application Publication
(10) Pub. No.: US 2007/0143775 A1
(43) Pub. Date: Jun. 21, 2007

(54) Methods and systems to determine pricing of Internet protocol television services

(76) Inventors: Raghvendra G. Savoor, Walnut Creek, CA (US); Stephen A. Sposato, Lafayette, CA (US); Canhui Ou, Danville, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/303,717

(22) Filed: Dec. 16, 2005

(51) Int. Cl. H04N 7/16

(52) U.S. Cl. 725/1

(57) ABSTRACT

Methods and systems to determine pricing for an Internet protocol media service are disclosed. A disclosed example method includes determining a first Internet protocol television service plan based on a first media presentation device type and a second Internet protocol television service plan based on a second media presentation device type. The first Internet protocol television service plan is offered to a user of the first media presentation device type and the second Internet protocol television service plan is offered to a user of the second media presentation device type.

### FIELD OF THE DISCLOSURE

The present disclosure relates generally to communication networks and, more particularly, to methods and systems to determine pricing of Internet protocol television services.

### BACKGROUND

Internet protocol television (“IPTV”) services use broadband Internet data delivery services to deliver television programming. The increased data rates of broadband wide area networks enables consumers to access television programming using IPTV services. IPTV services offer media programming using a variety of delivery properties including various bandwidth requirements, various screen resolutions, selectable viewing times (e.g., real-time, on-demand, etc.), etc.

In addition, IPTV services can deliver television programming to a plurality of different media presentation device types. For example, a subscriber may receive IPTV media programming via a television communicatively coupled to a set-top-box or receiver configured to receive and decode IPTV signals. Additionally, the subscriber may receive IPTV media programming via a computer, a portable computing device, a mobile phone, a personal digital assistant (“PDA”), etc. While some consumers may want to enjoy receiving high quality IPTV media via home entertainment centers, other, consumers may be drawn to IPTV services for other reasons such as, for example, mobile media access, low-cost service subscription packages, etc.

### BRIEF DESCRIPTION OF THE DRAWINGS

FIG. 1 depicts an example media delivery network system for Internet protocol television services.

FIG. 2 depicts an example price determination system that may be used to determine prices for Internet protocol television services.

FIGS. 3-7 depict example data structures that may be used to store ranking values for each type of service criterion used to implement the example price determination model of FIG. 2.

FIG. 8 depicts an example data structure that may be used to store weighted factor values used to implement the example price determination model of FIG. 2.

FIG. 9 is a block diagram of an example system.

FIG. 10 is a flowchart representative of machine readable instructions that may be executed to implement the example apparatus of FIG. 9.

FIGS. 11A AND 11B depict a flowchart representative of machine readable instructions that may be executed to perform a plurality of operations to determine a consumer price per subscriber for an Internet protocol television service offering.

FIG. 12 is an example processor system that may be used to implement the example methods and apparatus described herein.

### DETAILED DESCRIPTION

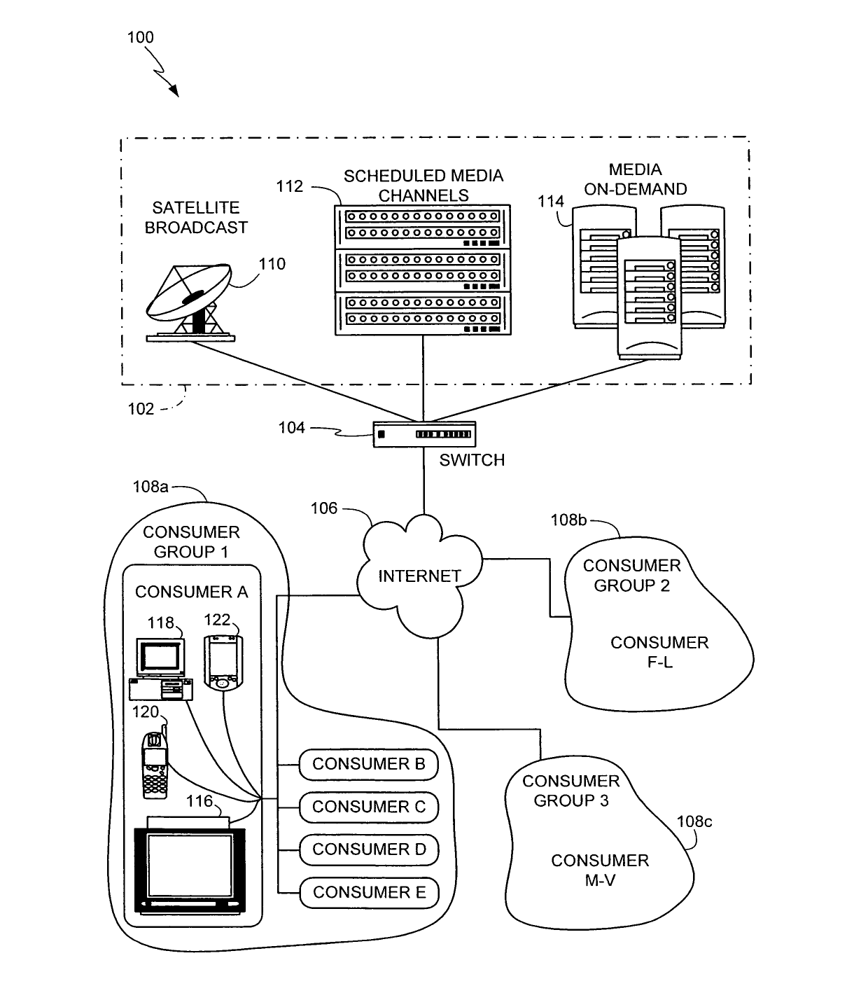

An example media delivery network system 100 for providing Internet protocol television (“IPTV”) services is illustrated in FIG. 1. The proposed methods and systems described herein may be used to determine pricing and billing models or structures for IPTV media delivery services. The media delivery industry includes numerous competitors, each of which offers a variety of media delivery services including different transmission mediums (e.g., cable, satellite, radio transmission, cellular transmission, etc.), different content types (e.g., movie channels, local network television channels, pay-per-view services, on-demand media access, Internet access, etc.), different media delivery qualities (e.g., standard-definition television, high-definition television, mobile video definition, etc.), etc. The proposed methods and systems enable IPTV media delivery service providers to offer different pricing and/or billing plans based on different media delivery service offerings associated with delivering television media over Internet protocol (“IP”) broadband networks.

The example methods and systems may be used to determine pricing and/or billing structures for IPTV media delivery services based on user groups or consumer groups (e.g., target classes of users) and a plurality of factors, parameters, and/or criteria (i.e., service criteria) associated with different aspects of the IPTV media delivery services that appeal to, or are preferred by, consumers of each consumer group. For example, IPTV media delivery services can be used to deliver media to a plurality of different media presentation device types including, for example, televisions, television set-top-boxes, personal computers (e.g., x86 compatible, Apple® compatible, etc.), mobile phones, personal digital assistants (“PDA's”) (e.g., wireless communicators), a portable media player (e.g., a mobile video player, a portable MP3 player, etc.), kiosks, etc.

Although some of the example implementations are described herein based on consumers, subscribers, or users, it should be noted that the example methods and systems may be used to determine service plans and pricing for users other than consumers and subscribers. For example, although persons may not be subscribers to a service, the example implementations may still be used to determine service plans and pricing based on information (e.g., preferences) associated with those persons. Also, the example methods and systems described herein may be implemented in connection with different categories of users, which may include businesses, organizations, families, individual persons, etc.

In an example implementation, the example methods and systems described herein may be used to determine service pricing or service plans for different target classes of users or consumers, each of which may prefer to receive IPTV media via a different media presentation device type or receiving device type. For example, an IPTV service provider may determine a first IPTV service plan for fixed-type users (e.g., subscribers watching television at home) that prefer to receive IPTV media services via televisions or computers and a second IPTV service plan for mobile users (e.g., business travelers or commuters) that prefer to receive IPTV media services via portable media devices (e.g., mobile phones, PDA's, MP3 players, etc.). In particular, the IPTV service provider may determine the first IPTV service plan (e.g., a prepaid subscription plan offered at a first price) based on a media presentation device type criterion indicative of televisions and the second IPTV service plan (e.g., a prepaid subscription plan offered at a second price) based on a media presentation device type criterion indicative of portable media devices.

Although the fixed-type users and the mobile users may all receive the same programming content, the service plans determined for each user type may differ based on the receiving media presentation device types. A consumer price for IPTV service plans offering high-quality media to the fixed-type users may be based on the amount of bandwidth required to deliver the higher quality media for presentation via a high-quality television. A consumer price for IPTV service plans offering mobile-accessible media to the mobile users may be based on the convenience associated with accessing IPTV media from anywhere and/or the costs of maintaining or leasing wireless communication infrastructures.

In another example implementation, some consumer groups may include high-definition (“HD”) television service subscribers, while other consumer groups may include standard-definition (“SD”) television service subscribers. In this case, definition quality (e.g., HD, SD, mobile-definition, etc.) is a first pricing parameter, media content costs (e.g., royalty fees, required bandwidth cost (higher bandwidth for HD), etc.) to the IPTV service provider may be a second pricing parameter, and the number of subscribers per group may be a third pricing parameter. To determine consumer prices unique to each of the two consumer groups, values associated with each of the three parameters (e.g., definition quality, media content cost, and number of subscribers per group) may be processed to determine a first consumer price associated with the high-definition subscriber group and a second consumer price associated with the standard-definition subscriber group. Pricing for IPTV media delivery services may be determined based on these and/or other types of service criteria as described below.

In the illustrated example implementation, determining consumer prices involves associating different weighted values with one or more of the parameter values or criterion values (e.g., the service criteria) associated with IPTV media delivery services. The weighted values may be used to determine which of the parameter values is more or less relevant to each pricing model for each consumer group. In an example implementation, the magnitudes of some weighted values assigned to different consumer groups may be based on the number of consumers or subscribers per consumer group (e.g., a consumer demand forecast). For example, consumer groups with relatively fewer consumers may be assigned relatively higher weighted values to ensure recovering the costs of delivering media to the consumers of that group despite the low consumer count. Additionally or alternatively, the magnitudes of other weighted values may be determined based on the value that each consumer group places on each factor, characteristic, or criteria. For example, a high-definition consumer group having predominately more pay-per-view subscribers than scheduled programming subscribers (i.e., flat-fee subscribers) may be assigned a relatively higher weighted value to a pay-per-view subscription parameter than another weighted value assigned to a scheduled programming subscription parameter.

Now turning in detail to FIG. 1, the example media delivery network system 100 includes a plurality of media sources 102, all of which are connected to a media source switch 104 that delivers media from each of the media sources 102 via the Internet 106 (e.g. via one or more broadband networks that communicate data to media presentation devices) to a plurality of consumer groups 108a-c (i.e., the user groups 108a-c). Example media sources depicted in FIG. 1 include a satellite broadcast source 110, a scheduled media source 112 that may be delivered via a plurality of channels, and a media on-demand source 114 that may deliver media on a per-request basis. The media source switch 104 may be used to select one of the plurality of media sources 102 based on the media content requested by a subscriber, consumer, user, etc. The switch 104 may also be used to cause the requested media to be delivered via a particular communication network selected by the subscriber such as, for example, a digital subscriber line (DSL) broadband network, a cable broadband network, an alternating current (AC) power line broadband network, a wireless communication broadband network (e.g., a wireless mobile phone network, a Wi-Fi network, a satellite network, etc.), etc. Although one switch (e.g., the media delivery switch 104) is shown in FIG. 1, the example media delivery network system 100 may be implemented with a plurality of switches, some of which may perform functions different from others (e.g., media source selector switches, network selector switches, etc.)

An IPTV service provider may use the example methods and systems described below to determine different consumer prices for at least some of the consumer groups 1 08a-c based on media or media delivery preferences, subscription types, etc. associated with the consumers of the consumer groups 108a-c. As shown, each of the consumer groups 108a-c includes a plurality of consumers A-E, F-L, and M-V. Each of the consumers may have a different set of preferences related to media or media delivery (e.g., media presentation device type preferences, media content preferences, media quality preferences, etc.) and may enter into different types of subscriptions or service agreements (e.g., scheduled programming, pay-per-view, on-demand, flat-rate billing, etc.) with an IPTV service provider. Each of the subscribers A-E, F-L, and M-V of the consumer groups 1 08a-c may have similar or different subscription types. As shown in connection with the consumer group 108a, consumer A has a subscription that allows subscriber A to receive IPTV media via a plurality of different media presentation device types including a television set-top-box 116, a personal computer 118, a mobile phone 120, or a portable media player 122 (e.g., a PDA).

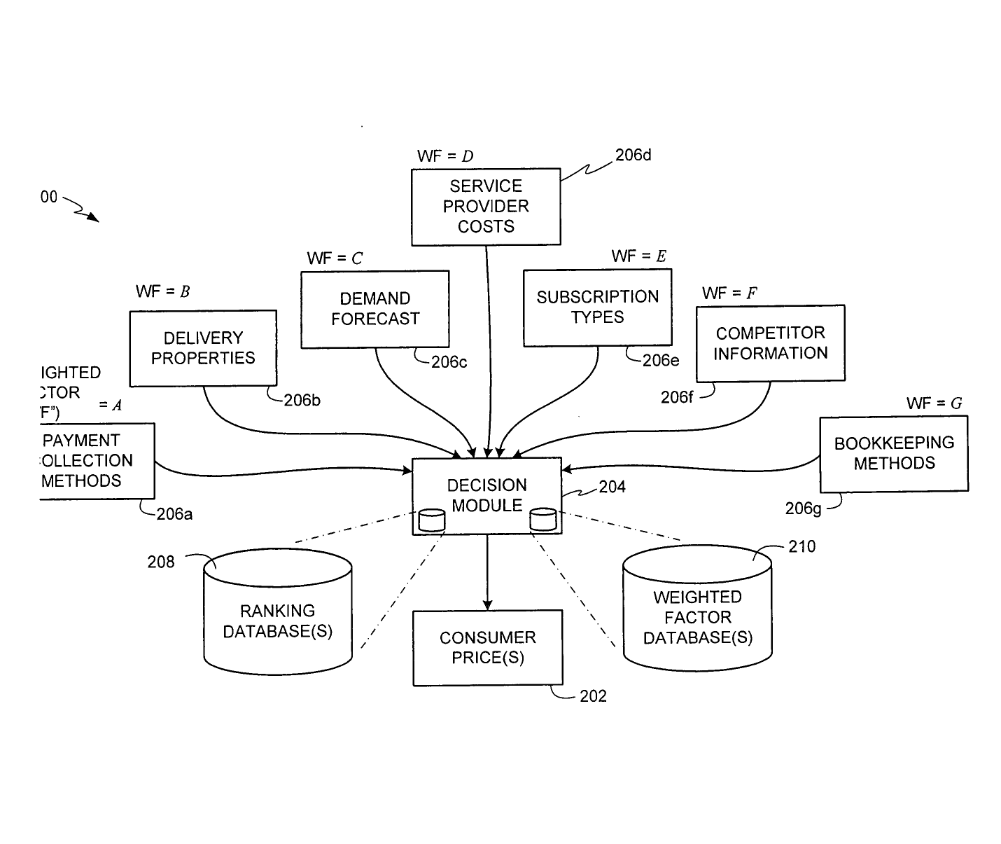

FIG. 2 depicts an example price determination system 200 that may be used to determine a consumer price 202 (e.g., the consumer pricing and/or billing structure) for IPTV media delivery services such as those described above in connection with FIG. 1. The example price determination model 200 uses a plurality of ranking values to rank service criteria associated with IPTV media delivery services, and to create a plurality of weighted factor values which, in turn, are used to determine the consumer price 202 for IPTV services offered based on target classes of consumers (e.g., the consumers of the consumer groups 108a-c of FIG. 1). Specifically, the example price determination model 200 includes a decision module 204 that obtains the ranking values, calculate the weighted factor values, and performs one or more operations using the weighted factor values as described below to determine the consumer price 202 associated with each target class of consumers.

Ranking values may be used to indicate consumer preferences for particular features (e.g., service criteria) of an IPTV media delivery service such as, for example, preferences for media presentation device types, media content types, media quality types, viewing times, subscription type, payment methods, etc. Ranking values may also be used to rank service criteria associated with IPTV service provider costs, service provider competitors, etc. For example, if the operating cost of a particular feature (e.g., premium movies), or technology resource (e.g., network infrastructure), or business model (e.g., marketing strategy) is relatively high, the IPTV service provider may rank that operating cost relatively higher than other costs because it has a relatively higher interest in recovering those operating costs. In another example, if a competitor aggressively markets a particular service, the IPTV service provider may rank a similar offering relatively higher than other service offerings to indicate a relatively high interest in offering competitive pricing for that service to minimize market share loss to the competition.

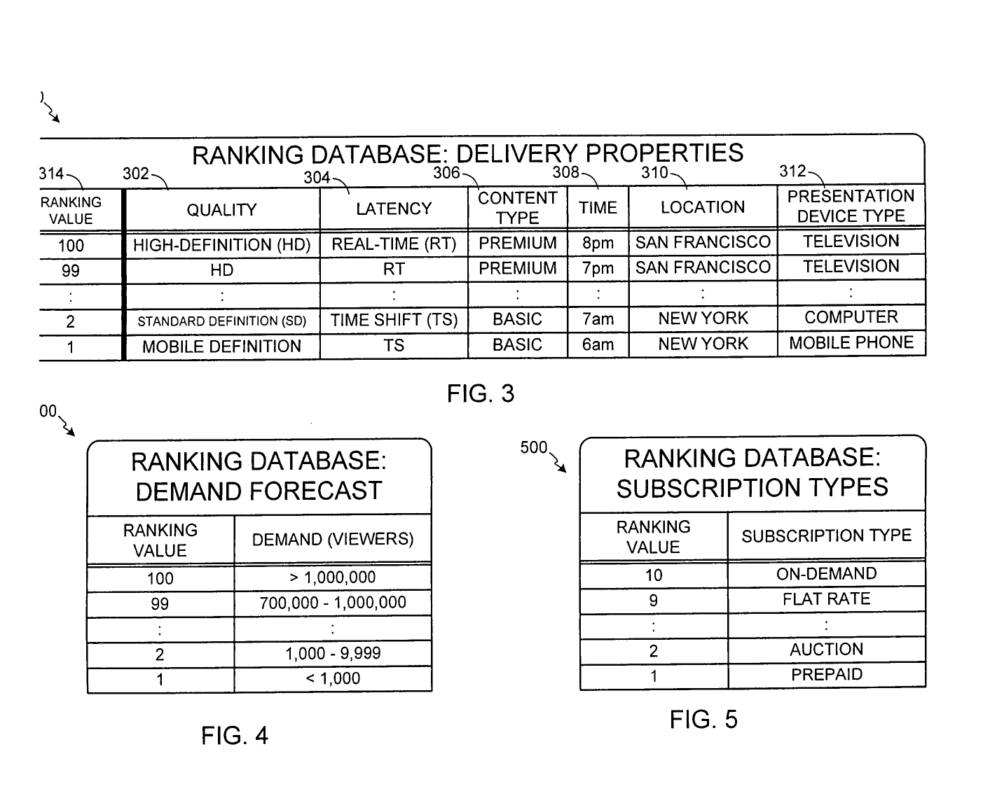

As shown in the example of FIG. 2, service criteria that may be provided a ranking value to be provided to the decision module 204 include payment collection methods criteria 206a, delivery properties criteria 206b (e.g., definition quality, schedule time, geographical location of delivery, media presentation device types, etc.), demand forecast criteria 206c (e.g., expected television program viewers), service provider costs criteria 206d (e.g., royalty fees, network infrastructure costs, bandwidth costs, employee costs, etc.), subscription types criteria 206e (e.g., pay-per-view, flat rate subscription, pre-paid, etc.), competitor information criteria 206f (e.g., pricings of similar service offers from competitors), and bookkeeping methods criteria 206g (e.g., electronic statements, paper statements, etc.). Each of the example types of service criteria are described in greater detail below in connection with FIGS. 3-7.

The ranking values may be determined in any suitable manner including via, for example, marketing studies. Although in some example implementations an IPTV service provider may group consumers categorically or otherwise before collecting consumer preference information to generate the ranking values, in other example implementations, the ranking values are based generally on an overall consumer or user populace. That is, consumers may be but need not be categorized into consumer groups (e.g., the consumer groups 108a-c) associated with different preferences or consumer categories (e.g., demographically categorized) before collecting consumer preference information to generate the ranking values.

To collect consumer preference information, a marketing group for an IPTV service provider may conduct consumer market studies using, for example, questionnaires or observation techniques to determine the preferences of consumers generally for each of a plurality of service criteria associated with IPTV media delivery services. Service criteria for which the surveyed consumers have relatively more preference may be assigned a ranking value of relatively greater magnitude than service criteria for which the surveyed consumers have relatively less preference. To determine ranking values associated with service features related to IPTV service provider resources or business aspects, the marketing group may collect information within the business operations of the IPTV service provider. For example, the marketing group may collect operating costs and expenses, infrastructure availabilities, technology capabilities, etc. In the illustrated example, the survey results are used to generate ranking values accordingly.

For the purpose of storing the ranking values associated with the service criteria-206a-g, the example system 200 of FIG. 2 includes one or more ranking databases 208 (i.e., one or more ranking data structures). The ranking databases or data structures 208 associate specific ranking values with the service criteria on which the decision module 204 bases the consumer price 202. For example, each of the ranking databases 208 may store ranking values indicative of preferences of an entire consumer populace (e.g., all of the consumers in some or all of the consumer groups 108a-c). The ranking databases 208 are described in greater detail below in connection with FIGS. 3-7.

Weighted factor values indicate the effectualness that the different types of service criteria 206a-g have on the consumer price 202. In the example of FIG. 2, each of the types of service criteria 206a-g is associated with a different one of a plurality of weighted factors (“WF”) A-G. In an example implementation, the weighted factor values A-G are determined for each consumer group. Consequently, any two consumer groups may have different values for the same weighted factor (e.g., different values for the weighted factor (A)). To determine weighted factor values, a marketing group may categorize or group people into different consumer groups (e.g., the consumer groups 108a-g of FIG. 1) based on different preferences toward different IPTV service features. As a result, for a consumer group having, for example, a high preference level for high-quality media, the decision module 204 may determine the consumer price 202 for that consumer group using a weighted value that increases the effect of the delivery properties criteria 206b on the consumer price 202. In another example, for a consumer group that has a relatively higher preference for the type of subscription (e.g., on-demand, pay-per-view, scheduled programming, etc.), the decision module 204 may then determine the consumer price 202 for that consumer group using a weighted value that increases the effect of the subscription types criteria 206e on the consumer price 202.

The weighted factor values may be determined in any suitable manner including, for example, via marketing studies as described above in connection with determining the ranking values. In addition, some of the weighted factor values may be determined based on respective ranking values stored in the ranking databases 208. For example, the decision module 204 may determine a weighted factor value by multiplying a respective ranking value (i.e., a ranking value associated with the same service characteristic as the weighted factor value in question) by a multiplier or scale value (e.g., [weighted factor]=[ranking value]×[scale value]).

For the purpose of storing weighted factor values A-G, the example system of FIG. 2 includes one or more weighted factor databases 210 (i.e., one or more weighted factor data structures). For each consumer group (e.g., each of the consumer groups 108a-c), the weighted factor databases or data structures 210 are used to associate weighted factor values with respective service criteria. In this manner, the weighted factor values may be used to indicate the preferences uniquely associated with each of the consumer groups 108a-c. Example weighted factor databases 210 are described in detail below in connection with FIG. 8.

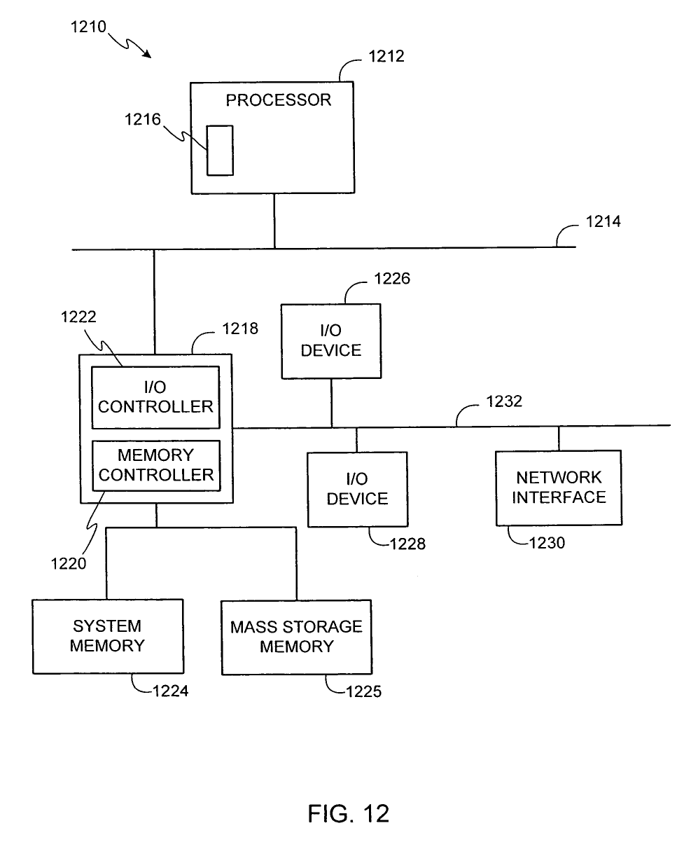

FIGS. 3-7 depict example data structures that may be used to store ranking values for each of the types of service criteria 206a-g used to implement the example price determination model 200 of FIG. 2. The data structures described below in connection with FIGS. 3-7 may be stored in and/or used to implement the ranking databases 208 described above in connection with FIG. 2. The example data structure of FIGS. 3-7 may be implemented using, for example, look-up tables, relational databases, or any other suitable data structures. Also, the example data structures of FIGS. 3-7 may be stored in, for example, removable media disk drives, hard disk drives, network drives, or any other suitable storage device (e.g., the mass memory storage memory 1225 of FIG. 12).

FIG. 3 depicts an example delivery properties data structure 300 used to rank combinations of the delivery properties criteria 206b including, for example, quality criteria, latency criteria, content type criteria, time criteria, location criteria, and media presentation device types. In other example implementations fewer or more delivery properties may be represented or stored in the delivery properties data structure 300.

The quality criteria 302 may be used to indicate, for example, the media quality to be delivered in terms of display line and pixel resolution (e.g., high-definition video, standard-definition video, mobile-definition video, etc.). The quality criteria 302 may also indicate audio quality (e.g., sampling rate, compression ratios, etc.) or other still image or video quality criteria (e.g., compression ratios, number of colors, etc.).

The latency criteria 304 may be used to indicate, for example, whether the IPTV media is viewed in real-time (i.e., during a normal scheduled broadcasting time) or whether the media is viewed using time-shifting features (e.g., digital video storage for later viewing). The content type criteria 306 may be used to indicate, for example, the value or grade of the IPTV media content (e.g., premium or basic). The time criteria 308 may be used to indicate, for example, a scheduled delivery or broadcast time and/or a time at which consumers typically request to view the IPTV media content. The location criteria 310 may be used to indicate, for example, the geographical location in which the IPTV media content is delivered or broadcasted at the time indicated in the time characteristic. The media presentation device type criteria 312 may be used to indicate, for example, the device type (e.g., a television, a computer, a mobile phone, a portable media device, etc.) to which the IPTV media is delivered.

The example delivery properties data structure 300 of FIG. 3 also includes a plurality of ranking values 314 which are assigned to a plurality of combinations of the delivery properties criteria 206b. In the illustrated example, a ranking value of ‘100’ is assigned to a combination of the delivery properties criterion 206b including a high-definition (“HD”) quality criterion, a real-time (“RT”) latency criterion, a premium content type criterion, an 8 pm time criterion, a location of San Francisco, and a television media presentation device type. In this case, the example delivery properties data structure 300 indicates that relatively more consumers in the consumer populace corresponding to the example table of FIG. 3 prefer the delivery properties characteristic combination assigned the ranking value 100 than other combinations assigned ranking values lower than 100.

In an example implementation, the decision module 204 (FIG. 2) receives a combination of the delivery properties criteria 206b associated with one of the consumer groups 108a-c (FIG. 1) and uses the example delivery properties data structure 300 to retrieve the ranking value associated with that combination and a factor to be considered in the process to determine the consumer price 202 (FIG. 2) for that consumer group.

FIG. 4 depicts an example demand forecast data structure 400 that may be used to associate ranking values to the number of consumers expected to view particular media programs. In the illustrated example, the demand forecast data structure 400 is used to assign higher ranking values to demand forecasts indicating relatively more viewers. For instance, the demand forecast criteria 206c (FIG. 2) may include a particular number of viewers in a consumer group of interest that are expected to use the IPTV service at a particular time or expected to view a particular IPTV media program. The decision module 204 may use the demand forecast data structure 400 to retrieve the ranking value associated with that particular number of viewers as a factor used in the process to determine the consumer price 202 to be provided to the corresponding consumer group.

FIG. 5 depicts an example subscription types data structure 500 that may be used to associate ranking values to a plurality of subscription or account types that are available to consumers for subscribing to IPTV media delivery services. In the illustrated example, relatively more consumers in the consumer populace associated with the data structure 500 have a relatively higher preference to on-demand subscriptions than to prepaid subscriptions.

In an alternative implementation of the example subscription types data structure 500, the ranking values may be determined based on interests or preferences of an IPTV service provider rather than on those of the consumer populace or consumer populace requirement. For example, an IPTV service provider may prefer to sell prepaid subscriptions over on-demand subscriptions and, thus, prepaid subscriptions would be assigned a relatively higher ranking value than on-demand subscriptions.

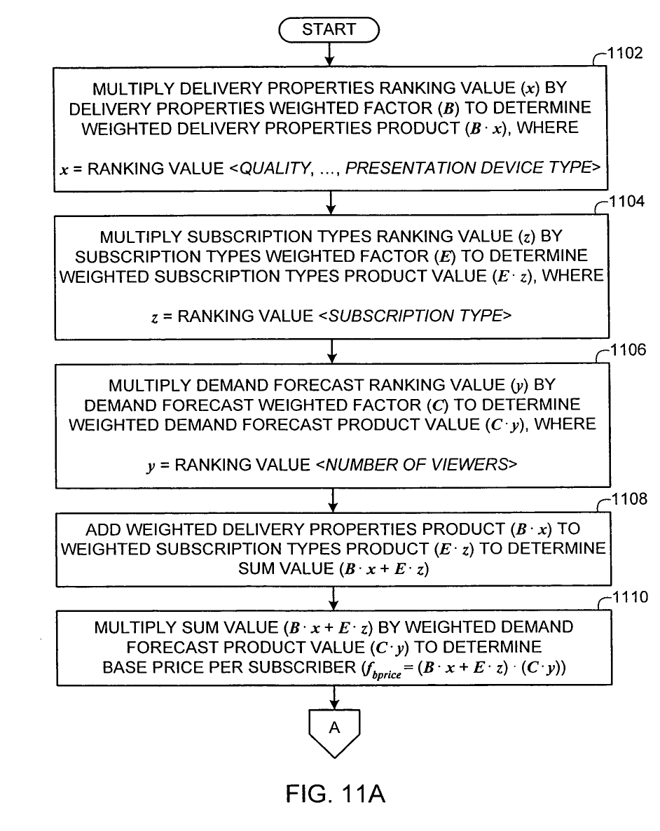

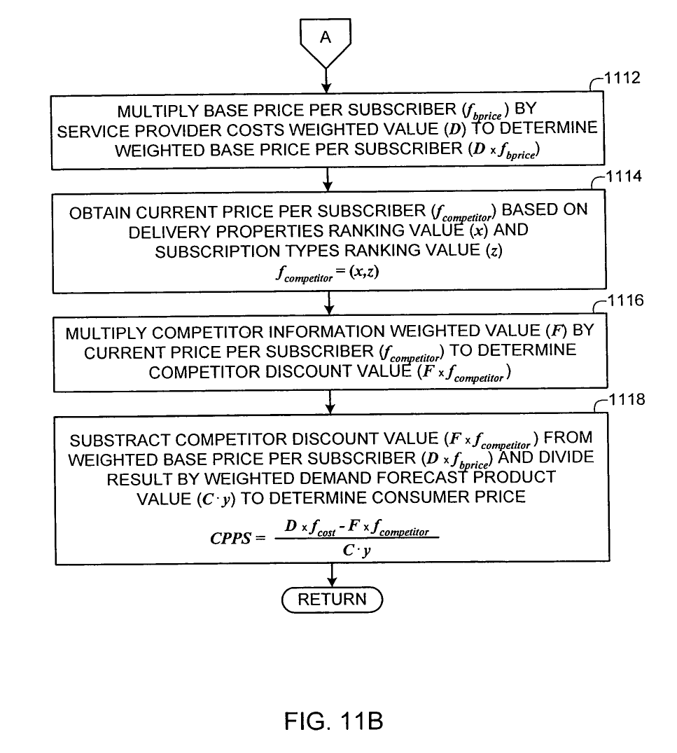

In some cases, higher ranking values stored in a criteria data structure (e.g., the example subscription types data structure 500) may indicate that a consumer is willing to pay more and, thus, will have an increasing effect on the consumer price 202 of FIG. 2. In other cases, if the higher ranking values indicate that an IPTV service provider is interested in selling a particular feature and is willing to charge less, the ranking values will have a decreasing effect on the consumer price 202. The effect that particular ranking values have on the consumer price 202 may be based on the types of functions or operations used to determine the consumer price 202 based on the ranking values as described below in connection with FIGS. 10, 11A, and 11B. For example, if a higher ranking value indicates a willingness of a consumer to pay more for a particular feature, then an addition operation may be selected to add the higher ranking value to a base service price. In contrast, if the higher ranking value indicates a willingness of an IPTV service provider to charge less, then a subtraction operation may be used to subtract the higher ranking value from the base service price.

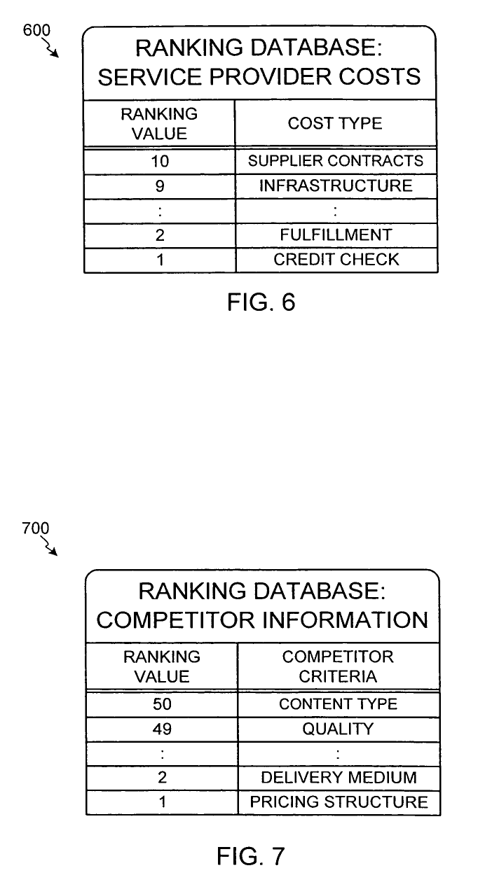

FIG. 6 depicts an example service provider costs data structure 600 that may be used to associate ranking values to the types of costs paid by an IPTV service provider. In the illustrated example, costs associated with a higher dollar amount may be associated with relatively higher ranking values, which may indicate that the IPTV service provider has a relatively high interest in recovering those costs and/or that a relatively higher consumer price for services is required to recover those costs.

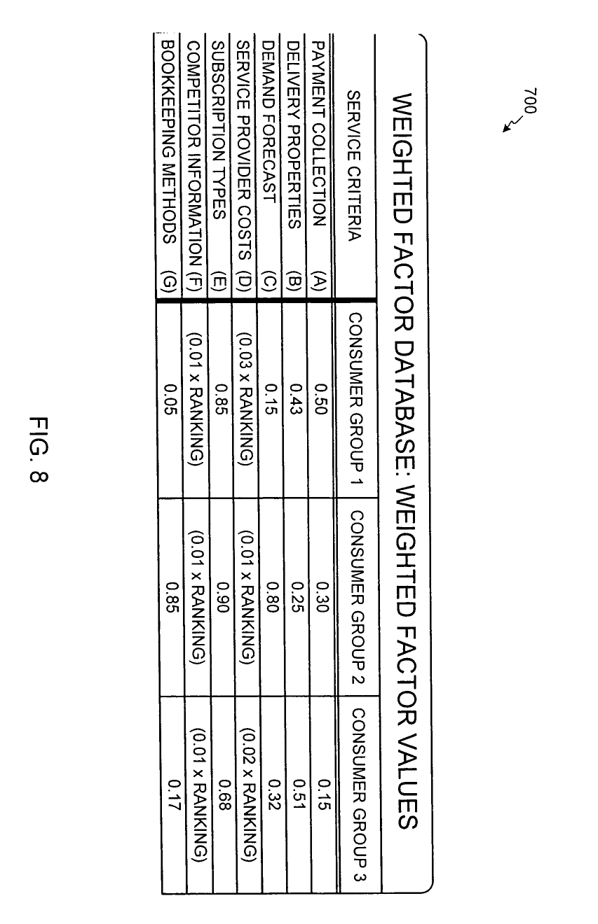

FIG. 7 depicts an example competitor information data structure 700 that may be used to associate ranking values to information associated with competitor products and/or services. In the illustrated example, relatively higher ranking values may be assigned to competitor product and/or service offerings that seem to be sought after relatively more than other products and/or services. Alternatively or additionally, the competitor information may be ranked based on the number of competitors that are offering similar products and/or services. As another alternative, higher values may be assigned to competitor products that are inferior to capitalize on competitive advantage.

Although the criteria described above in connection with FIGS. 3-7 are described as ranked according to particular criteria types and ranking methods, the criteria may additionally or alternatively be ranked according to any other criteria type and/or ranking method. For example, criteria described above as being ranked based on consumer preferences may additionally or alternatively be ranked based on interests of IPTV service providers. Also, in other example implementations, fewer or more media service criteria and/or data structures for storing and ranking the information may be used.

FIG. 8 depicts an example weighted factor values data structure 800 that may be used to store weighted factor values (e.g., the weighted factor values A-G of FIG. 2) which are used to implement the example price determination model 200 of FIG. 2. The example weighted factor values data structure 800 may be stored in, and/or used to implement, one or more of the weighted factor databases 210 of FIG. 2. The weighted factor values data structure 800 includes descriptions of the service criteria 206a-g described above in connection with FIGS. 2-7, and each of the service criteria 206a-g is denoted by one of the weighted factor values A-G. The weighted factor values data structure 800 may be implemented using, for example, a look-up table, a relational database, or any other suitable data structure. Also, the weighted factor values data structure 800 may be stored in, for example, a removable media disk drive, a hard disk drive, a network drive, or any other suitable storage device (e.g., the mass memory storage memory 1225 of FIG. 12).

In the illustrated example, the weighted factor values A-G are based on a range from zero to five. In this manner, the consumer price 202 may be determined by increasing or decreasing profit margin of a base consumer price according to the magnitude of the weighted values A-G. Also, in the illustrated example, a different set of the weighted factor values A-G is associated with each of the consumer groups 108a-c (FIG. 1). For example, the weighted factor value A for the payment collection method characteristic is associated with a value having a relatively higher magnitude for consumer group 1 (e.g., the consumer group 108a of FIG. 1) than for consumer group 2 (e.g., the consumer group 108b of FIG. 1). Also, for consumer group 1, the example weighted factor values data structure 800 is used to associate a relatively higher weighted factor value E (i.e., 0.85) to the subscription types criteria 206e (FIG. 2) than the weighted factor value B (i.e., 0.45) associated with the delivery properties criteria 206b (FIG. 2).

The illustrated example decision module 204 (FIG. 2) may determines the consumer price 202 (FIG. 2) for the consumer group 108a by assinging the highest weight (e.g., E=0.85) to the subscription types criteria 206e of the consumer group 108a and giving the lowest weight (e.g., G=0.05) to the bookkeeping methods criteria 206g of the consumer group 1. Example calculations or operations that the decision module 204 may use to determine the consumer price 202 are described in greater detail below in connection with FIG. 10.

In some example implementations, one or more of the weighted values A-G may be generated based on the ranking values stored in the ranking databases 208 (FIG. 2). For example, as shown in FIG. 8, the weighted factor value (F) for the competitor information criteria 206f (FIG. 2) is determined by multiplying the value ‘0.01’ by the ranking value associated with a particular competitor service, package, or product offering in the competitor information data structure 700 (FIG. 7). In the illustrated example, the decision module 204 (FIG. 2) determines the competitor information weighted factor value (F) for the consumer group 1 by obtaining a name, identification, and/or description of a competitor service, package, offering, etc. from the competitor information criteria 206f, retrieving a respective ranking value from the competitor information data structure 700 (FIG. 7), and multiplying the retrieved ranking value by the value ‘0.01’ as indicated in FIG. 8. In this manner, if an IPTV service provider has a relatively high interest in competitively pricing particular service offerings, the IPTV service provider can subtract the monetary value represented by the competitor information weighted factor value (F) (or a product of the weighted factor value (F) and another value) from an otherwise typical consumer price offered by the IPTV service provider for the particular service offering.

In addition, as described above, the decision module 204 may be configured to compare the retrieved ranking values of the competitor information criteria 206f to a threshold value to determine whether to use the weighted factor value (F) in determining the consumer price 202. In this manner, the decision module 204 can determine when to consider that competitor information criteria 206f in determining the consumer price 202. In an example implementation, an IPTV service provider may predetermine one or more threshold values corresponding to one or more of the service criteria 206a-g to indicate the minimum ranking values that one or more of the service criteria 206a-g must achieve to be used in determining the consumer price 202.

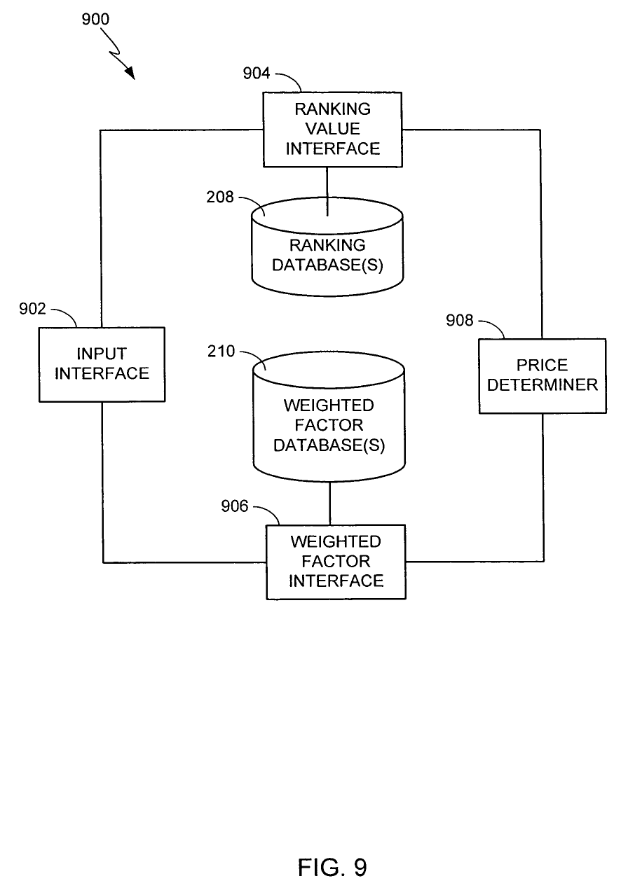

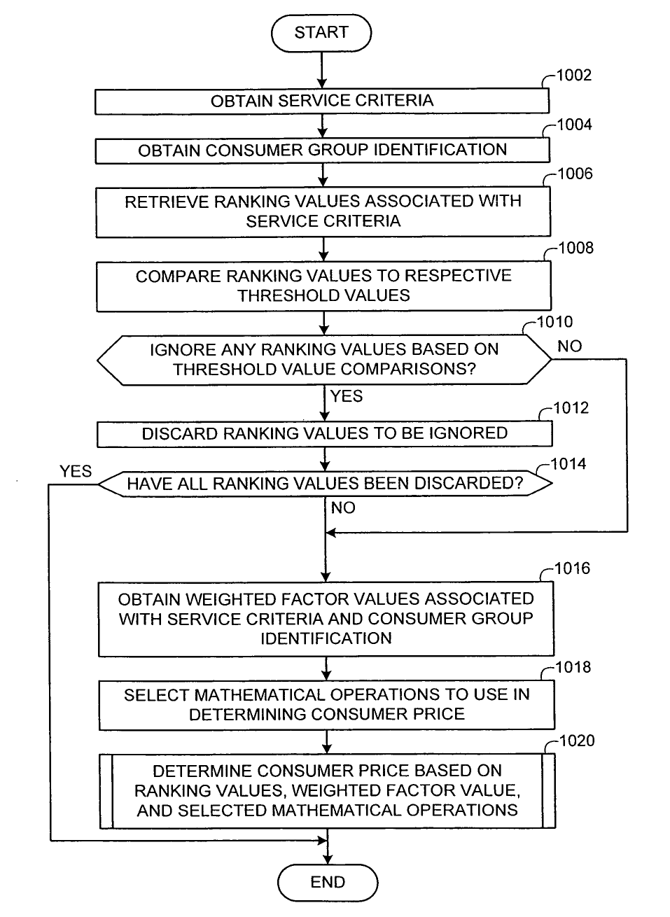

FIG. 9 is a block diagram of an example system 900 for implementing the example decision module 204 of FIG. 2. The example system 900 may be implemented using any desired combination of hardware, firmware, and/or software. For example, one or more integrated circuits, discrete semiconductor components, or passive electronic components may be used. Additionally or alternatively, some or all of the blocks of the example system 900, or parts thereof, may be implemented using instructions, code, and/or other software and/or firmware, etc. stored on a machine accessible medium that, when executed by, for example, a processor system (e.g., the example processor system 1210 of FIG. 12), perform the operations represented in the flow diagrams of FIGS. 10, 11A, and 11B.

For the purpose of providing information, including the service criteria 206a-g described above in connection with FIGS. 2-7, the example system 900 is provided with an input interface 902. The input interface 902 may be implemented using a user interface (e.g., a keyboard, a touch-screen, or any other human interface device), a data storage interface (e.g., a removable media disk drive, a hard disk drive, a network interface, etc.), or any other type of interface suitable for providing information such as the service criteria 206a-g to the example system 900. For example, combinations of the delivery properties criteria 206b may be stored on a network server and provided to the example system 900 via a network interface used to implement the input interface 902.

For the purpose of retrieving ranking values from the ranking database(s) 208, the example system 900 is provided with a ranking value interface 904. The ranking value interface 904 is communicatively coupled to the input interface 902 and the ranking database(s) 208. In the illustrated example, the ranking value interface 904 obtains information including at least some of the service criteria 206a-g (FIG. 2) from the input interface 902 and retrieves ranking values corresponding to the received service criteria 206a-g from at least some of the ranking databases 208 (e.g., some or all of the data structures 300, 400, 500, 600, and 700 of FIGS. 3-7).

For the purpose of retrieving weighted factor values from the weighted factor database(s) 210, the example system 900 of FIG. 9 is provided with a weighted factor interface 906. The weighted factor interface 906 is communicatively coupled to the input interface 902 and the weighted factor database(s) 210. In the illustrated example, the weighted factor interface 906 obtains from the input interface 902 information including at least some of the service criteria 206a-g and identification information indicating one or more consumer groups (e.g., one or more of the consumer groups 108a-c)for which consumer prices 202 are to be determined. The weighted factor interface 906 then accesses the weighted factor database(s) 210 (e.g., the example weighted factor data structure 800 of FIG. 8) to retrieve one or more of the weighted values A-G (FIGS. 2 and 8) associated with the received service criteria 206a-g and the one or more identified consumer groups.

For the purposes of determining the consumer prices 202 (FIG. 2), the example system 900 is provided with a price determiner 908. The price determiner 908 is communicatively coupled to the ranking value interface 904 and the weighted factor interface 906. The price determiner 908 receives retrieved ranking values from the ranking value interface 904 and weighted factor values from the weighted factor interface 906. The price determiner 908 may use one or more types of functions, operations, and/or algorithms to determine the consumer prices 202 for particular IPTV services based on the received ranking values and weighted factor values. For example, the price determiner 908 may be configured to implement at least some of the operations described below in connection with FIGS. 10, 11A, and 11B to determine the consumer prices 202.

The ranking value interface 904, the weighted factor interface 906, and the price determiner 908 may be used to implement portions of or all of the example decision module 204 of FIG. 2. Alternatively, the example decision module 204 of FIG. 2 may be implemented by at least one or some of the ranking value interface 904, the weighted factor interface 906, and/or the price determiner 908.

Flowcharts representative of example machine readable instructions for implementing the example system 900 of FIG. 9 are shown in FIGS. 10, 11A, and 11B. In these examples, the machine readable instructions comprise a program for execution by a processor such as the processor 1212 shown in the example processor system 1210 of FIG. 12. The program may be embodied in software stored on a tangible medium such as a CD-ROM, a floppy disk, a hard drive, a digital versatile disk (DVD), or a memory associated with the processor 1212 and/or embodied in firmware and/or dedicated hardware in a well-known manner. For example, any or all of the input interface 902, the ranking value interface 904, the weighted factor interface 906, and/or the price determiner 908 could be implemented by software, hardware, and/or firmware. Further, although the example program is described with reference to the flowcharts illustrated in FIG. 10, persons of ordinary skill in the art will readily appreciate that many other methods of implementing the example system 900 may alternatively be used. For example, the order of execution of the blocks may be changed, and/or some of the blocks described may be changed, eliminated, or combined.

As shown in FIG. 10, the input interface 902 initially obtains information including one or more of the service criteria 206a-g described above in connection with FIGS. 2-7 (block 1002). For example, the input interface 902 may obtain the subscription types criteria 206e (FIGS. 2 and 5), a combination of one or more of the delivery properties criteria 206b (FIGS. 2 and 3), etc. from a network storage device, a human input device, a removable storage device, a local storage device, etc. The identities of the delivery properties criteria 206b may be based on the typical delivery property preferences of a particular consumer group (e.g., one of the consumer groups 108a-c of FIG. 1) for which pricing is desired. The retrieved service criteria may identify one or more media presentation device types (e.g., one or more of a television descriptor, a computer descriptor, a mobile phone descriptor, a PDA descriptor, etc.) preferred by that consumer group.

The input interface 902 then obtains one or more consumer group identifications (block 1004) (e.g., identification information indicating one or more of the consumer groups 108a-c) . For example, if the combination of delivery properties criteria 206b obtained at block 1002 is indicative of the delivery property preferences of the consumer group 108a, then the input interface 902 would obtain identification information indicative of the consumer group 108a so that the price determiner 908 can determine the consumer price 202 to be offered to the consumer group 108a for a particular service.

The ranking value interface 904 then retrieves the ranking values associated with the service criteria obtained at block 1002 (block 1006). For example, if the input interface 902 obtains a combination of delivery properties criteria 206b at block 1002, the ranking value interface 904 may then access the ranking databases 208 (FIG. 2) (e.g., access the delivery properties data structure 300 of FIG. 3) to retrieve the ranking value associated with the obtained combination of delivery properties criteria 206b.

The ranking value interface 904 compares some or all of the retrieved ranking values to respective threshold values (block 1008) to determine whether the price determiner 908 should or should not use the compared ranking values to determine the consumer price 202. For example, if at block 1002 the input interface 902 obtains the service provider costs criteria 206d (FIGS. 2 and 6) and at block 1006 the ranking value interface 904 retrieves a service provider cost ranking value for a particular service provider cost from the example data structure 600 of FIG. 6, then at block 1008 the ranking value interface 904 may compare the retrieved service provider cost ranking value with a predetermined service provider cost ranking threshold value to determine if the IPTV service provider has sufficient interest in basing the consumer price 202 on the particular service provider cost associated with the retrieved service provider cost ranking value.

The ranking value interface 904 then determines whether any of the retrieved ranking values should be ignored based on the threshold comparisons (block 1010). For example, if some of the retrieved ranking values did not meet or exceed respective threshold values, then the ranking value interface 904 determines that it should ignore those ranking values. If at block 1010 the ranking value interface 904 determines that it should ignore one or more of the retrieved ranking values, then the ranking value interface 904 discards the one or more ranking values to be ignored (block 1012) and determines whether all of the retrieved ranking values have been discarded (block 1014).

If the ranking value interface 904 determines at block 1014 that not all of the retrieved ranking values have been discarded or if the ranking value interfaces 904 determines at block 1010 that none of the retrieved ranking values should be ignored, then control advances to block 1016. At block 1016, the weighted value interface 906 obtains the weighted factor values (e.g., one or more of the weighted values A-G of FIGS. 2 and 8) associated with the service criteria obtained at block 1002 and the consumer group identification obtained at block 1004. For example, if the input interface 902 obtains a consumer group identification for the consumer group 108a and a combination of delivery properties criteria, then the weighted value interface 906 accesses the weighted value database 210 to retrieve the weighted factor value (B) associated with the consumer group 108a for the delivery properties criteria (e.g., ‘0.43’ in the example of FIG. 8).

Additionally or alternatively, to obtain a weighted factor value (block 1016), if the input interface 902 obtains the competitor information criteria 206f for the consumer group 108a, then the weighted value interface 906 accesses the weighted value database 210 to retrieve the scaling factor ‘0.01’ and multiplies the scaling factor ‘0.01’ by the ranking value retrieved at block 1006 for the competitor information to determine the weighted factor value (F) (block 1016).

The price determiner 908 then selects one or more mathematical operations to use in determining the consumer price 202 (block 1018). For example, the price determiner 908 may select from one or more mathematical operations based on the service criteria, the consumer group identification information, and/or any other criteria that are, for example, received by the example decision module 204 of FIG. 2. For example, the price determiner 908 may select a linear function or a non-linear function to use in determining the consumer price 202. For example, if the input interface 902 obtains: (a) service criteria associated with the service provider cost criteria 206d (FIG. 2), (b) the competitor information 206f, and (c) the demand forecast criteria 206c, the example price determiner 908 of FIG. 9 selects the linear functions set forth below in Equations 1 through 3.

$$\begin{matrix}CPPS = \frac{D \times {f}_{bprice} - F \times {f}_{competitor}}{C \times y} , where & Equation 1 \\ {f}_{bprice} = ( B \cdot x + E \cdot z ) \cdot C \cdot y , and & Equation 2 \\ {f}_{competitor} = f ( x , z ) & Equation 3\end{matrix}$$

The price determiner 908 may use Equations 1-3 to determine the consumer price 202 or the consumer price per subscriber (“CPPS”) as described below based on a delivery properties ranking value (x) for the delivery properties criteria 206b, a demand forecast ranking value (y) associated with the demand forecast criterion 206c, a subscription types ranking value (z) for the subscription types criteria 206e, the delivery properties weighted factor value (B) for the delivery properties criteria 206b, the demand forecast weighted factor value (C) for the demand forecast criteria 206c, the service provider cost weighted factor value (D) for the service provider costs criteria 206d, the subscription types weighted factor value (E) for the subscription types criteria 206e, the competitor information weighted factor value (F) for the competitor information 206f, a base price per subscriber function (f_{bprice}), and a competitor information function (f_{competitor})

In the illustrated example, the ranking value interface 904 retrieves the ranking values (x), (y), and (z) at block 1006 based on the service criteria obtained at block 1002 and the weighted value interface 906 obtains the weighted factor values (B), (C), (D), (E), and (F) at block 1008 based on the service criteria obtained at block 1002 and the consumer group identifications obtained at block 1004.

In other example implementations, the price determiner 908 may select any other suitable function(s) other than those shown above in Equations 1-3 to determine the consumer price 202. In some example, the price determiner 908 may select a function based on the meanings of the ranking values associated with some or all of the service criteria 206a-g (FIG. 2) and stored in the example data structures 300-700 of FIGS. 3-7. For example, if higher ranking values associated with a particular criterion indicate that consumers are willing to pay more for a particular feature, then the price determiner 908 may select a function different from a function that it would otherwise select if the higher ranking values indicate that an IPTV service provider was willing to charge less for the feature. In any case, the price determiner 908 may select a suitable function(s) for determining the consumer price 202 based on any suitable guidelines or rules.

After the price determiner 908 selects one or more operations at to use in determining the consumer price 202 (i.e., the CPPS) (block 1018), the price determiner 908 determines the consumer price 202 based on the ranking values (x), (y), and (z), on the weighted factor values (B), (C), (D), (E), and (F), and on the selected mathematical operations (block 1020) as described in detail in connection with the flowcharts of FIGS. 11A and 11B.

As shown in FIG. 11A, to determine the base price per subscriber (f_{bprice}) according to Equation 2 above, the example price determiner 908 multiplies the delivery properties ranking value (x) for the consumer group of interest by the corresponding delivery properties weighted factor value (B) to determine a weighted delivery properties product value (B·x) (block 1102). The example price determiner 908 then multiplies the subscription types ranking value (z) for the consumer group of interest by the corresponding subscription types weighted factor value (E) to determine a weighted subscription types product value (E·z) (block 1104). The example price determiner 908 then multiplies the demand forecast ranking value (y) for the consumer group of interest by the corresponding demand forecast weighted factor value (C) to determine a weighted demand forecast product value (C·y) (block 1106). The example price determiner 908 then adds the weighted delivery properties product value (B·x) to the weighted subscription types product value (E·z) to determine a sum value (B·x+E·z ) (block 1108). Subsequently, the example price determiner 908 multiplies the sum value (B·x+E·z) by the weighted demand forecast product value (C·y) to determine the base price per subscriber value (f_{bprice}=(B·x+E·z)·C·y) (block 1110) according to Equation 2 above.

As shown in FIG. 11B, the example price determiner 908 then multiplies the base price per subscriber value (f_{bprice}) by the service provider costs weighted factor value (D) to determine a weighted base price per subscriber value (D×f_{bprice}) (block 1112) as shown in Equation 1 above. In the illustrated example, the weighted base price per subscriber value (D×f_{bprice}) is representative of the base price per subscriber that an IPTV service provider must charge to recover one or more particular service provider costs. For example, the example price determiner 908 may determine the consumer price 202 (CPPS) using the weighted base price per subscriber value (D×f_{bprice}) if a ranking value for an IPTV service provider cost exceeds a predetermined threshold value indicating that the IPTV service provider has sufficient interest in recovering the IPTV service provider cost.

The example price determiner 908 then obtains a current price per subscriber value (f_{competitor}) based on the delivery properties ranking value (x) and the subscription types ranking value (z) (block 1114) corresponding to, for example, a particular service offering. In the illustrated example, to determine a value for the consumer price 202 (FIG. 2) that is competitive with a substantially similar or identical competitor service offering, the competitor function (f_{competitor}) of Equation 3 above may be used to return a current price per subscriber of the IPTV service provider for an IPTV service based on the subscription types ranking value (z) and the ranking value (x).

The example price determiner 908 may then multiply the competitor information weighted factor value (F) by the current price per subscriber (f_{competitor}) to determine the competitor discount product value (F×f_{competitor}) (block 1116). In the illustrated example, the competitor discount product value (F×f_{competitor}) is representative of the amount by which the IPTV service provider is willing to reduce its weighted base price per subscriber product value (D×f_{bprice}) to attract a particular consumer group. For cases in which an IPTV service provider does not elect to compete on price with a competitor, the competitor discount value (F×f_{competitor}) may be zero or otherwise ignored so that the consumer price 202 is substantially similar in magnitude or equal to the base price per subscriber (D×f_{bprice}).

The example price determiner 908 then subtracts the competitor discount product value (F×f_{competitor}) from the weighted base price per subscriber product value (D×f_{bprice}) and divides the result by the weighted demand forecast product value (C·y) to determine the consumer price 202 (CPPS) to be offered to the respective consumer group (block 1118) according to Equation 1 above. In the illustrated example, the weighted demand forecast product value (C×y) is representative of a factor that the IPTV service provider may use to further reduce the weighted base price per subscriber product value (D×f_{bprice}) based on the interest or desire of the IPTV service provider to sell a particular subscription type.

After the price determiner 908 determines the consumer price 202 (CPPS) (block 1118), control is passed back to, for example, a calling function or process such as the process depicted by the flowchart of FIG. 10. In the process depicted by the flowchart of FIG. 10, after the price determiner 908 determines the consumer price 202 for the consumer group is greater (block 1020) or, if at block 1014 the ranking value interface 904 determines that all of the ranking values have been discarded, the process of FIG. 10 is ended and/or returns to, for example, a calling function or process. If at block 1014 the ranking value interface 904 determines that all of the ranking values have been discarded, the price determiner 908 may determine the consumer price 202 based on the weighted base price per subscriber product value (D×f_{bprice}) without modification (e.g., without adding or subtracting additional profit margin).

FIG. 12 is a block diagram of an example processor system that may be used to implement the systems and methods described herein. As shown in FIG. 12, the processor system 1210 includes a processor 1212 that is coupled to an interconnection bus 1214. The processor 1212 includes a register set or register space 1216, which is depicted in FIG. 12 as being entirely on-chip, but which could alternatively be located entirely or partially off-chip and directly coupled to the processor 1212 via dedicated electrical connections and/or via the interconnection bus 1214. The processor 1212 may be any suitable processor, processing unit or microprocessor. Although not shown in FIG. 12, the system 1210 may be a multi-processor system and, thus, may include one or more additional processors that are identical or similar to the processor 1212 and that are communicatively coupled to the interconnection bus 1214.

The processor 1212 of FIG. 12 is coupled to a chipset 1218, which includes a memory controller 1220 and an input/output (I/O) controller 1222. As is well known, a chipset typically provides I/O and memory management functions as well as a plurality of general purpose and/or special purpose registers, timers, etc. that are accessible to and/or used by one or more processors coupled to the chipset 1218. The memory controller 1220 performs functions that enable the processor 1212 (or processors if there are multiple processors) to access a system memory 1224 and a mass storage memory 1225.

The system memory 1224 may include any desired type of volatile and/or non-volatile memory such as, for example, static random access memory (SRAM), dynamic random access memory (DRAM), flash memory, read-only memory (ROM), etc. The mass storage memory 1225 may include any desired type of mass storage device including hard disk drives, optical drives, tape storage devices, etc.

The I/O controller 1222 performs functions that enable the processor 1212 to communicate with peripheral input/output (1/0) devices 1226 and 1228 and a network interface 1230 via an I/O bus 1232. The I/O devices 1226 and 1228 may be any desired type of I/O device such as, for example, a keyboard, a video display or monitor, a mouse, etc. The network interface 1230 may be, for example, an Ethernet device, an asynchronous transfer mode (ATM) device, an 802.11 device, a DSL modem, a cable modem, a cellular modem, etc. that enables the processor system 1210 to communicate with another processor system.

While the memory controller 1220 and the 1/0 controller 1222 are depicted in FIG. 12 as separate functional blocks within the chipset 1218, the functions performed by these blocks may be integrated within a single semiconductor circuit or may be implemented using two or more separate integrated circuits.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method of pricing Internet protocol media services, comprising:
determining a first Internet protocol television service plan based on a first media presentation device type;
determining a second Internet protocol television service plan based on a second media presentation device type;
offering the first Internet protocol television service plan to a user of the first media presentation device type; and
offering the second Internet protocol television service plan to a user of the second media presentation device type.

2. A method as defined in claim 1, wherein the first Internet protocol television service plan is a prepaid service plan.

3. A method as defined in claim 1, wherein determining the first Internet protocol television service plan comprises determining the first Internet protocol television service plan based on a ranking value and a weighted factor value associated with the first media presentation device type.

4. A method as defined in claim 2, wherein the ranking value is indicative of a general preference of a user populace toward using the first media presentation device type.

5. A method as defined in claim 2, wherein the weighted factor value is indicative of a preference of the user toward using the first media presentation device type.

6. A method as defined in claim 1, wherein the first media presentation device type is one of a television set-top-box, a personal computer, a mobile phone, a personal digital assistant, or a portable media player.

7. A method as defined in claim 1, wherein the first and second Internet protocol television service plans are associated with providing the same media programming content.

8. A system to price an Internet protocol media service, comprising:
a ranking value interface communicatively coupled to a first data structure and configured to retrieve a plurality of ranking values associated with a plurality of media presentation device types configured to receive an Internet protocol media service from the first data structure;
a weighted factor interface communicatively coupled to a second data structure and configured to retrieve weighted factor values associated with a user group from the second data structure via the input interface; and
a price determiner communicatively coupled to the ranking value interface and the weighted factor interface and configured to determine a price at which the Internet protocol media service is to be sold to the user group based on the plurality of ranking values and the plurality of weighted factor values.

9. A system as defined in claim 8, wherein the ranking value interface retrieves a second plurality of ranking values associated with a prepaid subscription type, and wherein the price determiner determines the price based on at least one of the second plurality of ranking values.

10. A system as defined in claim 8, wherein the ranking values are indicative of general preferences of a user populace toward using each of the plurality of media presentation device types.

11. A system as defined in claim 8, further comprising an input interface communicatively coupled to the ranking value interface and the weighted factor interface to obtain the plurality of criteria information and communicate the criteria information to the ranking value interface and the weighted factor interface.

12. A system as defined in claim 8, wherein at least one of the ranking value interface and the weighted factor interface retrieves information from the data structures based on a target class of users associated with the user group.

13. A system as defined in claim 8, wherein the ranking value interface obtains a second plurality of ranking values from at least one data structure from at least one of a payment collection method, a media quality, a media demand forecast, a service provider cost, a subscription type, or competitor information.

14. A system as defined in claim 13, wherein the price determiner determines the price based on the other ranking values.

15. A system as defined in claim 8, wherein the plurality of media presentation device types includes at least one of a television set-top-box, a personal computer, a mobile phone, a personal digital assistant, or a portable media player.

16. A system as defined in claim 8, wherein the Internet protocol media service is an Internet protocol television service.

17. A machine accessible medium having instructions stored thereon that, when executed, cause a machine to:
obtain a weighted factor value for a plurality of media presentation device type criteria indicative of a plurality of media presentation device types associated with an Internet protocol media service; and
determine a price for the Internet protocol media service based on the weighted factor value and at least one of the media presentation device type criteria.

18. A machine accessible medium as defined in claim 17 having the instructions stored thereon that, when executed, cause the machine to determine the price based on a prepaid subscription type.

19. A machine accessible medium as defined in claim 17 having the instructions stored thereon that, when executed, cause the machine to obtain a plurality of ranking values associated with receiving the Internet protocol media services via the plurality of media presentation device types.

20. A machine accessible medium as defined in claim 19 having the instructions stored thereon that, when executed, cause the machine to determine the price for the Internet protocol media service based on the plurality of ranking values, wherein the ranking values are indicative of general preferences of a user populace toward using each of the plurality of media presentation device types.

21. A machine accessible medium as defined in claim 17, wherein the Internet protocol media service is an Internet protocol television service.

22. A machine accessible medium as defined in claim 17 having the instructions stored thereon that, when executed, cause the machine to obtain the weighted factor value based on a target class of users.

23. A machine accessible medium as defined in claim 17 having the instructions stored thereon that, when executed, cause the machine to obtain a second weighted factor value based on at least one of a payment collection method, a media quality, a media demand forecast, a service provider cost, a subscription type, or competitor information.

24. A machine accessible medium as defined in claim 23 having the instructions stored thereon that, when executed, cause the machine to determine the price based on the second weighted factor value.

25. A machine accessible medium as defined in claim 17, wherein the plurality of media presentation device types includes at least one of a television set-top-box, a personal computer, a mobile phone, a personal digital assistant, or a portable media player.
